(19) United States
(12) Patent Application Publication
(10) Pub. No.: US 2024/0393926 A1
(43) Pub. Date: Nov. 28, 2024

(54) HUMAN-MACHINE INTERFACE FOR A COCKPIT OF AN AIRCRAFT

(71) Applicant: Airbus Operations (S.A.S.), Toulouse (FR)

(72) Inventor: Benjamin Mazoin, Toulouse (FR)

(21) Appl. No.: 18/664,644

(22) Filed: May 15, 2024

(30) Foreign Application Priority Data
May 26, 2023 (FR) 2305274

(51) Int. Cl. G06F 3/04842; G06F 3/04812

(52) U.S. Cl. CPC G06F 3/04842; G06F 3/04812

(57) ABSTRACT

A display on a screen of human-machine interface of a cockpit of an aircraft includes a text entry region, a navigation chart region, and at least one other region. A specific pointing mode, active when text entry is in progress, and a normal pointing mode, active at all other times, are implemented. In normal pointing mode, a pointing action triggers the command if any associated with the location where the pointing action is carried out. In specific pointing mode, only a pointing action in the text entry region or in the navigation chart region triggers a command if any associated with the location where the pointing action is carried out, while a pointing action in the at least one other region triggers an abandonment of text entry. Thus, tasks requiring a pilot of the aircraft to enter text are simplified.

### TECHNICAL FIELD

The disclosure herein relates to a human-machine interface for an aircraft. More particularly, the disclosure herein relates to managing pointing actions in respect of a display on a screen of a human-machine interface of an aircraft.

### BACKGROUND

Usually, when a pilot wishes to enter information by a human-machine interface (HMI) of a cockpit of an aircraft, so as to have this information transmitted to the avionics of the aircraft, the pilot performs a pointing action in a text entry region provided in a display on a screen of the human-machine interface. In case of use a pointing device (such as a mouse, trackball or touchpad) the pointing action consists in moving a cursor to the text entry region by virtue of the pointing device and in clicking on this position to validate the pointing action. In case of use of a touch screen, the pointing action consists in touching the touch screen (sometimes with more than one finger, and possibly with a subsequent movement) in the text entry region in question.

Once the pointing action has been performed in the text entry region, the cursor is then confined to the text entry region. Often represented by a blinking vertical bar, the cursor remains confined until the pilot validates or abandons the text entry. Acting on another part of the screen leads to abandonment of text entry and information already entered, but not validated, is lost.

This may cause problems when the pilot wishes to consult, on a navigation chart displayable on the screen, information required by her or him to determine the information that she or he must enter in the text entry region, or indeed wishes to act on this navigation chart (zoom in, pan through the navigation chart, etc.). This may for example be a useful way of searching for information about a waypoint of a path of the aircraft that the pilot must enter in the text entry region. Thus, when the pilot must enter successive pieces of information relating to a plurality of waypoints, she or he must first retrieve this information from the navigation chart, then write down this information on a piece of paper, perform the pointing action in the text entry region, and lastly enter the pieces of information by virtue of a keyboard while referring to the information noted on the piece of paper.

It is therefore desirable to overcome these drawbacks of the prior art. In particular, it would be desirable to provide a solution allowing the text entry operations that must be carried out by an aircraft pilot via such a human-machine interface to be simplified.

### SUMMARY

A method for managing pointing actions in respect of a display on a screen of a human-machine interface of a cockpit of an aircraft is disclosed, the display comprising regions including a text entry region, a navigation chart region, and at least one other region, each region being associated with commands that are able to be activated by performing a pointing action in the region. A controller of the human-machine interface implements two pointing modes, one called the specific pointing mode, which is active when text entry is in progress in the text entry region, and the other called the normal pointing mode, which is active when no text entry is in progress in the text entry region, such that: in normal pointing mode, a pointing action in a region triggers the command if any associated with the location where the pointing action is carried out in the region in question; and in specific pointing mode, a pointing action in the text entry region or in the navigation chart region triggers the command if any associated with the location where the pointing action is carried out in the region in question, and a pointing action in the at least one other region triggers abandonment of text entry, the commands of the at least one other region being deactivated conversely to the commands of the text entry region and of the navigation chart region.

Thus, the text entry operations that must be carried out by an aircraft pilot via this human-machine interface are simplified, by virtue of implementation of these two pointing modes, allowing text to be entered while tolerating manipulation of an (aeronautical or airport) navigation chart.

In a particular embodiment, the controller assigns a keyboard of the human-machine interface specifically to text entry in specific pointing mode and assigns the keyboard to a general use of the human-machine interface in normal pointing mode.

In a particular embodiment, when abandonment of text entry is triggered, any information that has been entered into the text entry region but not validated is recorded in an entry history, an entry history access functionality being activated in specific pointing mode but not in normal pointing mode.

In a particular embodiment, any information that has been entered into the text entry region and validated is also recorded in the entry history.

In a particular embodiment, when the entry history access functionality is activated, the text entry region is expanded to display the entry history so as to partially overlap a region that is inactive in specific pointing mode.

Also provided here is a computer program product comprising program code instructions that cause any one of the embodiments of the above method to be implemented, when the instructions are executed by a processor of a human-machine interface of a cockpit of an aircraft. Also provided here is a data storage medium storing a computer program comprising program code instructions that cause any one of the embodiments of the above method to be implemented when the instructions are read and executed by a processor of a human-machine interface of a cockpit of an aircraft.

Also provided here is a human-machine interface for a cockpit of an aircraft, the human-machine interface comprising a screen and a controller, the controller comprising electronic circuitry configured to manage pointing actions in respect of a display on the screen, the display comprising regions including a text entry region, a navigation chart region, and at least one other region, each region being associated with commands that are able to be activated by performing a pointing action in the region. The electronic circuitry being configured to implement two pointing modes, one called the specific pointing mode, which is active when text entry is in progress in the text entry region, and the other called the normal pointing mode, which is active when no text entry is in progress in the text entry region, such that: in normal pointing mode, a pointing action in a region triggers the command if any associated with the location where the pointing action is carried out in the region in question; and in specific pointing mode, a pointing action in the text entry region or in the navigation chart region triggers the command if any associated with the location where the pointing action is carried out in the region in question, and a pointing action in the at least one other region triggers abandonment of text entry, the commands of the at least one other region being deactivated conversely to the commands of the text entry region and of the navigation chart region.

### BRIEF DESCRIPTION OF THE DRAWINGS

The above-mentioned features of the disclosure herein, as well as others, will become more clearly apparent on reading the following description of at least one example embodiment, the description being given with reference to the appended drawings, in which:

FIG. 1 schematically illustrates, in perspective, an aircraft;

FIG. 2 schematically illustrates one example of a display generated by a human-machine interface of a cockpit of the aircraft;

FIG. 3 schematically illustrates an algorithm for switching from a normal pointing mode to a specific pointing mode;

FIG. 4 schematically illustrates an algorithm for switching from the specific pointing mode to the normal pointing mode;

FIG. 5 schematically illustrates an algorithm of a method for managing pointing actions, depending on whether the human-machine interface is in specific pointing mode or in normal pointing mode;

FIG. 6 schematically illustrates the example of a human-machine interface of FIG. 2 after switching to specific pointing mode; and

FIG. 7 schematically illustrates an example of a hardware layout allowing the human-machine interface to be implemented.

### DETAILED DESCRIPTION

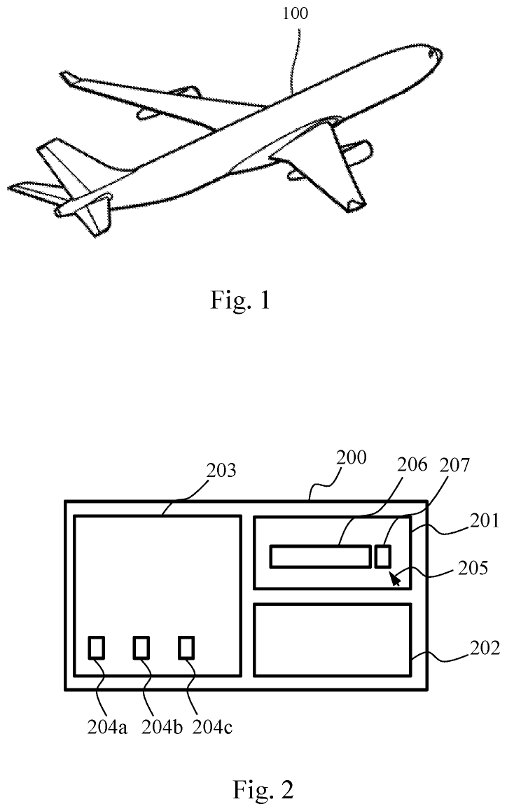

Thus, FIG. 1 schematically illustrates, in perspective, an aircraft 100. The aircraft 100 is equipped with avionics that have at least one human-machine interface. The human-machine interface is installed in the cockpit of the aircraft and is configured to allow a pilot of the aircraft to observe and manipulate information on a screen of the human-machine interface, and to enter information to be transmitted to the avionics of the aircraft. For example, the information entered is information on at least one waypoint of the aircraft according to a flight plan. The at least one waypoint may be identified on a (aeronautical or airport) navigation chart displayed on the screen. Other information may thus be entered by the pilot of the aircraft. An example of a hardware layout allowing the human-machine interface to be implemented is presented below with reference to FIG. 7.

As detailed below, the human-machine interface is configured to implement two (mutually exclusive) pointing modes, here called “normal pointing mode” and “specific pointing mode”.

FIG. 2 schematically illustrates an example of a display 200 generated by such a human-machine interface.

The display 200 comprises a text entry region 201. The display 200 may comprise a plurality of text entry regions. Via this text entry region 201, the pilot is able to enter information by virtue of a keyboard and transmit the entered information to the avionics. The text entry region 201 comprises a field 206 for displaying entered information and may comprise a virtual action button 207 for validating text entry. The text entry region 201 may further comprise a virtual action button (not shown) for abandoning text entry.

The specific pointing mode is active when text entry is in progress in the text entry region 201, and the normal pointing mode is active when no text entry is in progress in the text entry region 201.

The text entry region 201 is thus active in normal pointing mode and in specific pointing mode.

The display 200 comprises a navigation chart region 203. Via this navigation chart region 203, the pilot is able to manipulate one or more (aeronautical or airport) navigation charts. The navigation chart region 203 may contain various virtual action (command) buttons 204a, 204b, 204c, the associated actions (commands) relating to the content of the navigation chart region 203.

This navigation chart region 203 is compatible with text entry in parallel. The navigation chart region 203 is therefore active in normal pointing mode and in specific pointing mode.

Thus, in specific pointing mode, the text entry region 201 and the navigation chart region 203 are both active at the same time. These two regions 201 and 203 therefore have the focus simultaneously. In particular, an interaction in the navigation chart region 203 does not cause loss of focus from the text entry region 201, which thus preserves textual information already entered and which thus remains ready to receive a text entry after the interaction or even during the interaction. This allows a user, in particular a pilot, to start a text entry in the text entry region 201 by a text entry device (a keyboard for example), then to interact, by the human-machine interface, with the navigation chart in the navigation chart region 203 (for example to search for or verify information necessary for the text entry in progress) without losing information already entered in the text entry region 201, then to continue text entry in the text entry region 201. The user does not need to perform any specific action before continuing to enter text in the text entry region 201 after manipulation of the navigation chart 203: she or he only needs to continue entering text by the text entry device. For example, the user does not need to perform a specific action such as moving a cursor and clicking on the text entry region 201 before continuing with text entry.

The display 200 comprises another region 202. This region 202 is incompatible with text entry in parallel. Thus, this other region 202 is active in normal pointing mode, but is inactive in specific pointing mode. In other words, in specific pointing mode, a pointing action in the other region 202 does not activate a specific command that is associated with the location where the pointing action is carried out in the other region 202 and that would, in contrast, be executed in normal pointing mode. For example, this other region 202 is a region intended for entering a new heading of the aircraft, for modifying a current speed or altitude of the aircraft, for setting a frequency of VHF communication with air traffic control, etc.

When the human-machine interface comprises a pointing device other than the screen (such as a mouse, trackball or touchpad), to allow the pilot to use the human-machine interface the display 200 comprises a cursor 205 (represented by an arrow in FIG. 2). The pilot uses the pointing device in question to move the cursor 205 over the display 200, in order to carry out pointing operations in the location where the cursor 205 is positioned.

When the human-machine interface comprises a touch screen (and therefore no pointing device other than the screen), the display 200 does not require a cursor 205.

In normal pointing mode, the pilot is able to interact with each region of the display 200, i.e. commands specific to each region are activatable via a pointing action in the region (for example a pointing action activating a virtual button of the region in question). In specific pointing mode, the pilot is able to interact only with the text entry region 201 and the navigation chart region 203, i.e. only commands specific to the text entry region 201 and commands specific to the navigation chart region 203 are activatable via a pointing action in the region in question. The commands specific to each other region 202 are then deactivated.

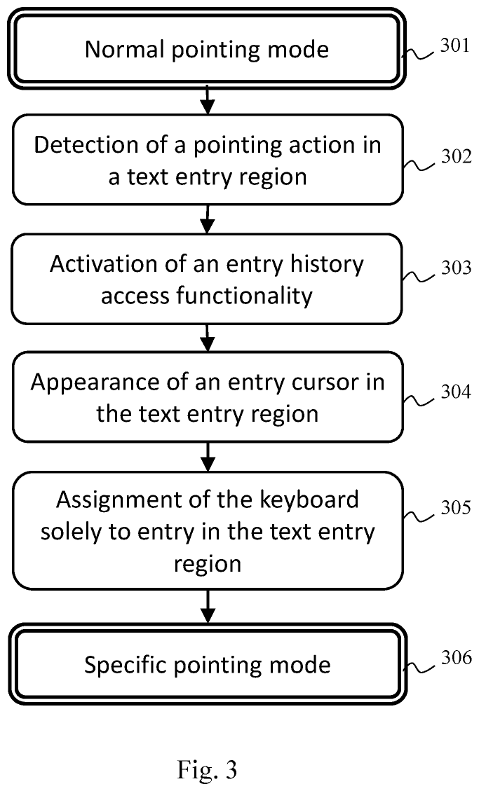

FIG. 3 schematically illustrates an algorithm for switching from normal pointing mode to specific pointing mode.

In a step 301, the human-machine interface is in normal pointing mode.

In a step 302, the human-machine interface detects a pointing action in the text entry region 201.

In an optional step 303, the human-machine interface activates an entry history access functionality. The entry history is a record of information previously entered in the text entry region 201, which information the pilot is subsequently able to access to repeat or continue entry of information.

In a step 304, the human-machine interface preferentially causes an entry cursor to appear in the field 206 for displaying entered information.

In a step 305, the human-machine interface assigns the keyboard solely to text entry in the text entry region 201. On the keyboard, only buttons that are intended for operations related to text entry are affected. Any other buttons not intended for operations related to text entry are not affected and may be assigned to a command related to the navigation chart region 203 (or a command to abandon text entry).

In a step 306, the human-machine interface switches to specific pointing mode. Next, the algorithm of FIG. 3 terminates.

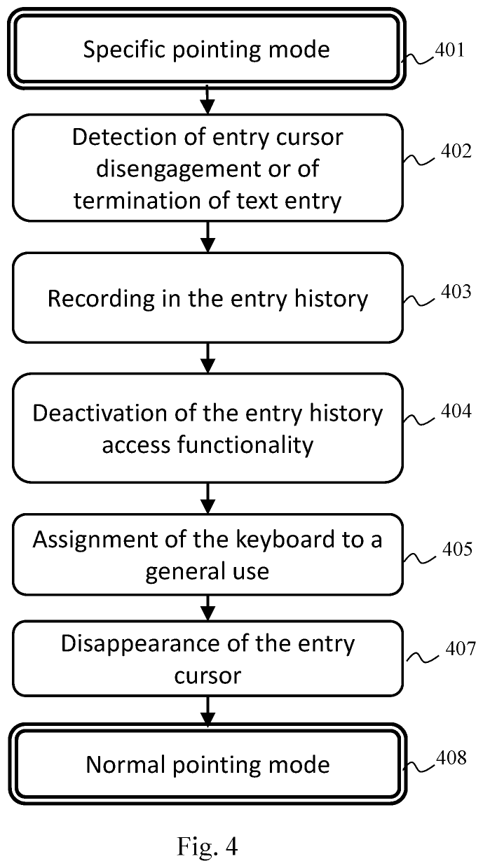

FIG. 4 schematically illustrates an algorithm for switching from specific pointing mode to normal pointing mode.

In a step 401, the human-machine interface is in specific pointing mode. Text entry is therefore in progress in the text entry region 201.

In a step 402, the human-machine interface detects disengagement of the entry cursor, i.e. abandonment of text entry, or validation of text entry. Text entry is for example validated by pressing a dedicated button on the keyboard (for example, a key labelled “ENTER”) or via a pointing action on the virtual action button 207 for validating text entry. Text entry is for example abandoned by pressing a dedicated button on the keyboard (for example, a key labelled “ESC”) or via a pointing action on a region that is inactive in specific pointing mode (region 202).

In a step 403, the human-machine interface records, in the entry history, the information present in the field 206 for displaying entered information (if the functionality for accessing such an entry history is implemented by the human-machine interface). If the field 206 for displaying entered information is empty, step 403 is omitted. In a particular embodiment, the human-machine interface records, in the entry history, the information present in the field 206 for displaying entered information only in the event of abandonment of text entry. This allows a text entry that was interrupted so that the pilot could execute an operation of higher priority to be returned to subsequently.

In a step 404 (if step 303 was performed), the human-machine interface deactivates the entry history access functionality.

In a step 405, the human-machine interface reassigns the keyboard to a general use of the human-machine interface. Thus, the buttons used for text entry may be used to activate commands in other regions of the display 200.

In a step 406, the human-machine interface causes the entry cursor to disappear from the field 206 for displaying entered information. When the human-machine interface detects validation of text entry in step 402, the human-machine interface makes the entered information disappear from the field 206 for displaying entered information. In a particular embodiment, the human-machine interface also makes the entered information disappear from the field 206 for displaying entered information when the human-machine interface detects abandonment of text entry in step 402.

In a step 407, the human-machine interface switches to normal pointing mode. Next, the algorithm of FIG. 4 terminates.

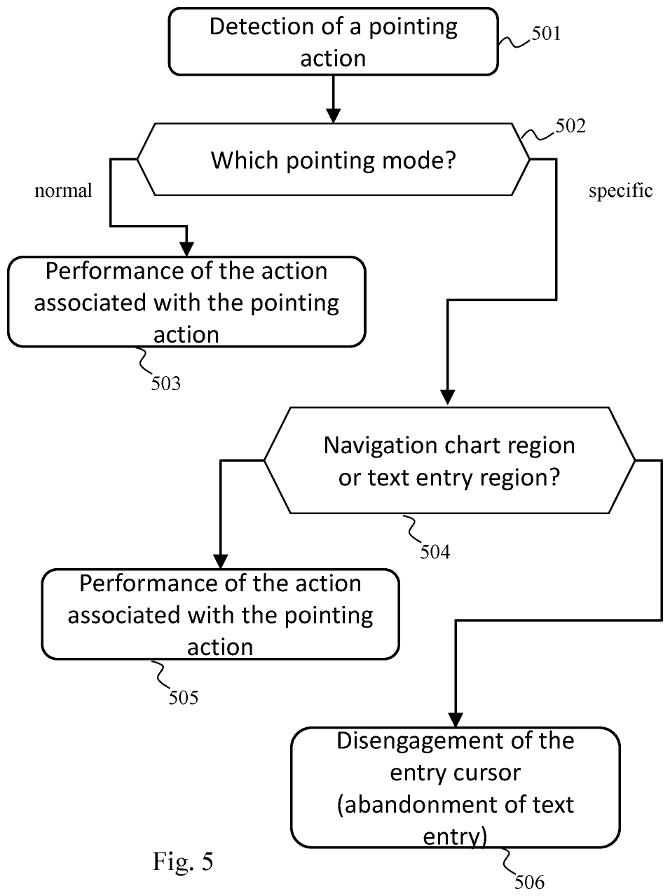

FIG. 5 schematically illustrates an algorithm of a method for managing pointing actions, depending on whether the human-machine interface is in specific pointing mode or in normal pointing mode.

In a step 501, the human-machine interface detects that a pointing action has been carried out.

In a step 502, the human-machine interface determines in which pointing mode the human-machine interface is. When the human-machine interface is in normal pointing mode, a step 503 is performed; otherwise, when the human-machine interface is in specific pointing mode, a step 504 is performed.

In step 503, the human-machine interface carries out an action (command) associated with the pointing action, independently of any restriction implied by the text entry in progress. The specific command, if there is one at the location where the pointing action is carried out, is carried out.

In step 504, the human-machine interface determines which region of the display 200 is concerned by the pointing action. When the region of the display 200 concerned by the pointing action is the text entry region 201 or the navigation chart region 203, a step 505 is performed; otherwise, a step 506 is performed.

In step 505, the human-machine interface carries out an action (command) associated with the pointing action. The specific command, if there is one at the location where the pointing action is carried out, is carried out. For example, a chart displayed in the navigation chart region 203 is zoomed into or panned over, or the entry cursor is moved in the text entry region 201. Next, the algorithm of FIG. 5 terminates.

In step 506, the human-machine interface disengages the entry cursor, i.e. the human-machine interface abandons text entry. Specifically, the pointing action was here carried out outside of the text entry region 201 and outside of the navigation chart region 203, while the specific pointing mode was activated (this meaning that the specific commands of any other region 202 are deactivated). The algorithm of FIG. 4 is therefore executed and the human-machine interface switches to normal pointing mode. Next, the algorithm of FIG. 5 terminates.

In a particular embodiment, when the cursor 205 is moved over the other region 202, a symbol is displayed on the screen to warn that the specific pointing mode is activated and that making a pointing action (clicking) on this other region 202 will cause the specific pointing mode to be exited from and the normal pointing mode to be returned to.

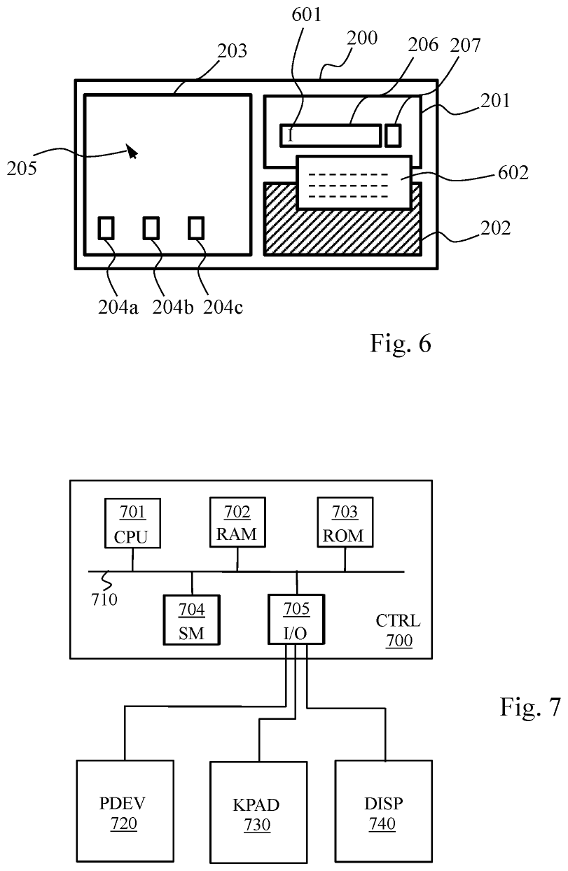

FIG. 6 schematically illustrates the example of a human-machine interface of FIG. 2 after switching to specific pointing mode.

In FIG. 6, the entry cursor 601 appears in the field 206 for displaying entered information. By way of illustration, the entry cursor 601 has an “I” shape. The entry cursor 601 may have another shape, for example a simple vertical bar. For example, the entry cursor 601 blinks to increase its visibility in the display 200.

In FIG. 6, the region 202 is hatched to schematically show that the region 202 is inactive in specific pointing mode. Thus, a pointing action in the region 202 triggers an exit from the specific pointing mode, and the text entry in progress in the text entry region 201 is abandoned.

In specific pointing mode, a notification bar may be integrated into the display 200 to indicate that the specific pointing mode is activated. Such a notification bar may as a variant be displayed temporarily on change to pointing mode (specific pointing mode activated/deactivated).

In a particular embodiment, in the specific pointing mode, the display 200 may be modified with respect to FIG. 2 by placing an opaque layer over the region 202 to explicitly indicate that specific pointing mode is enabled.

In FIG. 6, the text entry region 201 has been enriched to display the entry history 602, in which the pilot may perform a pointing action to select a text entry recorded beforehand in the entry history, and thus reiterate a previous entry or continue with an abandoned text entry in progress. Such a situation occurs when the entry history functionality is accessed (for example, a pointing action on a virtual button of the text entry region 201 allows it to be accessed, or indeed the entry history 602 is automatically displayed when text entry is activated).

To enrich the text entry region 201 with the entry history 602, the text entry region may be expanded to partially cover a region 202 that is inactive in specific pointing mode. Preserving a partial display of the region 202 makes it possible to continue to see information that may be displayed therein, and also to easily abandon text entry if necessary.

A pointing action in the text entry region 201 triggers the command if any associated with the location of the text entry region 201 where the pointing action is carried out. For example, a pointing action on the virtual action button 207 for validating text entry validates the information entered in the field 206 for displaying entered information.

A pointing action in the navigation chart region 203 triggers the command if any associated with the location of the navigation chart region 203 where the pointing action is carried out. For example, a pointing action involving two fingers and subsequent separation of the two fingers at the centre of the navigation chart region 203 triggers a zoom into a navigation chart displayed in the navigation chart region 203. According to another example, a pointing action on the virtual button 204a triggers an action associated with the virtual button 204a.

FIG. 7 schematically illustrates an example of a hardware layout allowing the human-machine interface to be implemented.

The human-machine interface comprises a controller CTRL 700, a keyboard KPAD 730 and a screen DISP 740. The screen DISP 740 may be a touch screen, for example one using resistive or capacitive technology. The human-machine interface may comprise a pointing device PDEV 720 distinct from the screen DISP 740 (such as a mouse, trackball or touchpad), more particularly when the screen DISP 740 is not a touch screen and is used solely to project the display 200.

In the example of the hardware layout of FIG. 7, the controller CTRL 700 comprises, connected by a communication bus 710: a central processing unit CPU 701; a random-access memory RAM 702; a read-only memory 703, for example an electrically erasable programmable ROM (EEPROM) or a flash ROM; a storage unit, such as storage medium SM 704 like a hard disk drive (HDD) or such as a reader of a storage medium like an SD card reader (SD standing for Secure Digital); and an input/output interface manager I/O 705.

The input/output manager I/O 705 allows the controller CTRL 700 to interact with the keyboard KPAD 730, the screen DISP 740 and the pointing device PDEV 720.

The central processing unit 701 is capable of executing instructions loaded into the random-access memory 702 from the read-only memory 703, from an external memory, from a storage medium (such as an SD card) or from a communication network (not shown). When the human-machine interface is turned on, the central processing unit 701 is capable of reading instructions from the random-access memory 702 and of executing them. These instructions form a computer program causing the central processing unit 701 to implement the steps and algorithms described here.

All or some of the steps and algorithms described here may thus be implemented in software form by executing a set of instructions using a programmable machine, for example a digital signal processor (DSP) or a microcontroller, or be implemented in hardware form by a machine or a dedicated chip or chipset, for example a field-programmable gate array (FPGA) or an application-specific integrated circuit (ASIC). Generally, the controller CTRL 700 comprises electronic circuitry designed and configured to implement the steps and algorithms described here.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for managing pointing actions in respect of a display on a screen of a human-machine interface of a cockpit of an aircraft, the display comprising regions including:
a text entry region;
a navigation chart region; and
at least one other region;
each region being associated with commands that can be activated by performing a pointing action in the region;
a controller of the human-machine interface implementing two pointing modes, one of the two pointing modes being a specific pointing mode, which is active when text entry is in progress in the text entry region, and another of the two pointing modes being a normal pointing mode, which is active when no text entry is in progress in the text entry region, such that:
in normal pointing mode, a pointing action in a region triggers a command if any associated with a location where the pointing action is carried out in a region in question; and
in specific pointing mode, a pointing action in the text entry region or in the navigation chart region triggers the command if any associated with the location where the pointing action is carried out in a region in question, and a pointing action in the at least one other region triggers abandonment of text entry, the commands of the at least one other region being deactivated conversely to the commands of the text entry region and of the navigation chart region.

2. The method according to claim 1, wherein, in specific pointing mode, the controller assigns focus both to the text entry region and to the navigation chart region, to allow a user to perform steps of:
entering text in the text entry region;
interacting, by the human-machine interface, with the navigation chart in the navigation chart region without losing information already entered in the text entry region;
continuing text entry in the text entry region without needing to carry out any specific action before continuing text entry.

3. The method according to claim 1, wherein the controller assigns a keyboard of the human-machine interface specifically to text entry in specific pointing mode and assigns the keyboard to a general use of the human-machine interface in normal pointing mode.

4. The method according to claim 1, wherein, when abandonment of text entry is triggered, any information that has been entered into the text entry region but not validated is recorded in an entry history, an entry history access functionality being activated in specific pointing mode but not in normal pointing mode.

5. The method according to claim 4, wherein any information that has been entered into the text entry region and validated is also recorded in the entry history.

6. The method according to claim 4, wherein, when the entry history access functionality is activated, the text entry region is expanded to display the entry history to partially overlap a region that is inactive in specific pointing mode.

7. A computer program product comprising program code instructions that cause the method according to claim 1 to be implemented when the instructions are executed by a processor of a human-machine interface of a cockpit of an aircraft.

8. A data storage medium storing a computer program comprising program code instructions that cause the method according to claim 1 to be implemented when the instructions are read and executed by a processor of a human-machine interface of a cockpit of an aircraft.

9. A human-machine interface for a cockpit of an aircraft, the human-machine interface comprising a screen and a controller, the controller comprising electronic circuitry configured to manage pointing actions in respect of a display on the screen, the display comprising regions including:
a text entry region;
a navigation chart region; and
at least one other region;
each region being associated with commands that are able to be activated by performing a pointing action in the region;
the electronic circuitry being configured to implement two pointing modes, one of the two pointing modes being the specific pointing mode, which is active when text entry is in progress in the text entry region, and another of the two pointing modes being the normal pointing mode, which is active when no text entry is in progress in the text entry region, such that:
in normal pointing mode, a pointing action in a region triggers the command if any associated with a location where the pointing action is carried out in a region in question; and
in specific pointing mode, a pointing action in the text entry region or in the navigation chart region triggers the command if any associated with the location where the pointing action is carried out in a region in question, and a pointing action in the at least one other region triggers abandonment of text entry, the commands of the at least one other region being deactivated conversely to the commands of the text entry region and of the navigation chart region.

10. The human-machine interface according to claim 9, wherein, in specific pointing mode, the electronic circuitry of the controller is configured to assign focus both to the text entry region and to the navigation chart region, to allow a user to perform a sequence of steps of:
entering text in the text entry region;
interacting, by the human-machine interface, with the navigation chart in the navigation chart region without losing information already entered in the text entry region;
continuing text entry in the text entry region without needing to carry out any specific action before continuing text entry.
